(19) United States
(12) Patent Application Publication
(10) Pub. No.: US 2023/0226656 A1
(43) Pub. Date: Jul. 20, 2023

(54) ANGLE STOP

(71) Applicant: Festool GmbH, Wendlingen (DE)

(72) Inventor: Bjoern SCHERRAUS, Filderstadt (DE)

(21) Appl. No.: 17/866,873

(22) Filed: Jul. 18, 2022

(30) Foreign Application Priority Data
Jan. 18, 2022 (DE) 20 2022 100 251.7

(51) Int. Cl. B23Q 3/00

(52) U.S. Cl. CPC B23Q 3/005

(57) ABSTRACT

A system and method for operating an angle stop having a first body, a second body, and a connector arrangement with a work component. The method includes placing the work component on a workpiece surface of a workpiece, contacting the first body having a first workpiece contact surface with a workpiece side surface of the workpiece, contacting the second body having a work component contact surface with the work component, fixing the work component to the second body, and fixing an angle between the first body and the second body.

### CROSS REFERENCE TO RELATED APPLICATIONS

This application is based on, claims priority to, and incorporates herein by reference for all purposes, German Utility Model 20 2022 100 251.7, filed on Jan. 18, 2022.

### FIELD

The present invention relates to an angle stop or a guide assembly or an angle guide assembly having variable angle fixing, in particular an angle stop or a guide assembly or an angle guide assembly in which the angle between a workpiece and a work component or guide rail can be fixed rapidly and precisely.

### BACKGROUND

When machining workpieces using hand-held machines, in particular in the field of application of a mechanic, there is frequently the desire to fix, in a precise and stable manner, guide rails, rulers or generally work components in relation to a workpiece to be machined.

In the prior art, angle stops are known which permit rapid fixing of a ruler orthogonally to a workpiece edge or side surface. Furthermore, angle stops are known which permit a variable angle orientation. However, these are frequently cumbersome to operate.

### SUMMARY

The invention provides an improved angle stop or improved guide assembly or angle guide assembly in accordance with any one of the independent claims, by means of which an angle between a workpiece and a work component is rapidly and precisely fixable, with developments of the angle stop being embodied in the dependent claims.

According to one embodiment, an angle stop is provided comprising: a first body having a first workpiece contact surface for contacting a workpiece side surface of a workpiece; a second body having a work component contact surface for contacting a work component to be fixed to the second body, wherein the work component in the fixed state is placeable on a workpiece surface of said workpiece; a connector arrangement for fixing the work component to the second body, wherein the connector arrangement is designed to fix said work component to be fixed, to the work component contact surface by a quick closure clamping process; and an angle fixing device; wherein the first body and the second body are connected together and are orientable with respect to each other in an angle-defined manner in a rotation plane for orienting the work component contact surface in relation to the workpiece contact surface in order to orient said work component to be fixed and being placeable on the workpiece surface, in relation to said workpiece side surface with respect to each other in an angle-defined manner; wherein the workpiece contact surface has a longitudinal extension direction in a rotation plane of the first body and of the second body, and a transverse extension direction with an inclination with respect to the rotation plane of the first body and of the second body; wherein the work component contact surface has a longitudinal extension direction in a rotation plane of the first body and of the second body, and a transverse extension direction with an inclination with respect to the rotation plane of the first body and of the second body; wherein the angle fixing device is designed to fix the first body and the second body with respect to each other in an angle-stable manner.

In this manner, a first body, which in this case is provided for contacting a workpiece, in particular a side surface or edge of a workpiece, can be rapidly and easily oriented with respect to a second body at a desired angle and the work component to be oriented can be coupled to the second body by the connector arrangement. This permits rapid and precise angle orientation and fixing of a work component.

A workpiece to be machined can be an object to be machined, e.g. a board, a plate, a beam, a log or the like. Workpieces are frequently made from wood, but can also be made from synthetic material, metal or composites of said materials.

In terms of the invention, “workpiece surface” is understood to mean a surface or side of a workpiece to be machined, on which a work component (or guide component) is placeable, oriented in an angle-defined manner, and on which typically a tool is also moved. For example, a tool-side table, for instance a carriage, a saw or a milling machine, is moved on or along this surface or (top) side of the workpiece. In the case of a circular saw, the saw blade (irrespective of a possible lateral approach) passes through this workpiece surface or side during machining.

A workpiece side surface is used for contacting the first body of the angle stop and, in terms of the invention, is understood to mean a surface or side of a workpiece which generally borders the workpiece surface. This surface or side generally extends from the workpiece surface in the direction of the side facing away from the workpiece surface. The workpiece side surface can extend perpendicularly to the workpiece surface and form e.g. a right angle therewith. The transition between workpiece surface and workpiece side surface can also be curved and have a continuous transition. The workpiece side surface can also extend with respect to the workpiece surface at an angle other than a right angle (e.g. in the form of a bevel). It will be understood that the workpiece side surface does not necessarily have to have a smaller extent than the workpiece surface. For instance, when machining a surface generally designated as a board edge, the board edge can be the workpiece surface and the board top or bottom side can be the workpiece side surface, on which the first body of the angle stop is placed.

A connector arrangement may be a quick connector system. A quick connection system for fixing the work component to the second body is understood to mean a connection system or means being actuated by a user, without an additional tool, in particular without a screwdriver or a spanner, in order to effect the process of fixing the work component to the second body. A quick connection system is understood to mean e.g. a connection component or connector arrangement which can be brought from the loose state to a fixed state of the work component to the second body by the user with only one hand movement or hand pivoting movement. A quick connection system, component or means may, for example, be a lever arrangement with a hook for engaging the work component and a handgrip for acting movable components for fixing the hook. A quick connection system, component or means can be e.g. a lever mechanism with one or more levers or a detent mechanism with one or more detents. The quick connection system, component or means in terms of the invention can permit rapid connection and optionally also rapid disconnection.

In terms of the invention, a “work component” is understood to mean an element being fixable in an angle-defined manner and which is used indirectly or directly for machining a workpiece. The work component can be a guide element or a guide rail for guiding a workpiece, for instance an electric tool, for instance a saw, for instance a plunge circular saw. The work component can also be designed as a component of a tool which as such already has a working direction. For instance, the table of a milling machine can be the work component, if the milling machine is moved in relation to the table. The work component can also be a ruler, along which a tool or a drawing instrument is guidable.

The “rotation plane” of the first body and of the second body is to be understood to mean the plane in which the first and second bodies rotate with respect to each other. The “rotation plane direction” of the first body and of the second body is to be understood to mean a direction in the rotation plane or a plane in parallel therewith.

According to one embodiment, the first body and the second body are orientable with respect to each other in an angle-defined manner in a rotation plane x-y about a centre of rotation.

In this manner, different angles are fixable and the work component is fixable at different angles with respect to the workpiece side surface.

According to one embodiment, the angle fixing device is swichable between a first state which allows rotation between the first body and the second body and a second state which blocks rotation between the first body and the second body.

In this manner, a simple change in the angle orientation can be effected, but nevertheless secure fixing of the selected angle can be effected.

According to one embodiment of the invention, the workpiece contact surface has a longitudinal extension direction in a rotation plane of the first body and of the second body, and a transverse extension direction perpendicular to the rotation plane of the first body and of the second body. In particular, the inclination of the workpiece contact surface is orthogonal to the rotation plane x-y of the first body and the second body.

In this manner, precise contacting of the workpiece contact surface of the first body on the workpiece can be generally effected, without the angle stop being lifted off from the workpiece surface. Even in the case of rounded transitions between the workpiece surface and workpiece side surface, when there is sufficient width, i.e. sufficient extension perpendicularly away from the workpiece surface beyond a rounded region, secure contact on the workpiece can be achieved.

According to one embodiment, the first body has a second workpiece contact surface for contacting a workpiece side surface, the surface normal direction of the second workpiece contact surface being opposite to the surface normal direction of the first workpiece contact surface. The two contact surfaces are oriented in opposite directions.

In this manner, the angle stop can be used on both sides and complex alteration measures and alteration times can be avoided. Furthermore, the second workpiece contact surface can be used in order to orient further components in parallel with the workpiece side surface because the second workpiece contact surface is oriented in parallel with the first workpiece contact surface.

According to one embodiment, the first body has an extension, which is coupleable, in the longitudinal extension direction of the first workpiece contact surface, wherein the extension being coupleable, has a workpiece contact surface in a planar continuation of at least one of the workpiece contact surfaces of the first body.

In this manner, the workpiece contact surface can be lengthened and the angle stop can be oriented precisely. Furthermore, longer lateral cut-outs in the workpiece side surface can be bridged if these are not longer than the first body and the extension, which can be coupled, together.

According to one embodiment, the first body has, spaced apart from a coupling region of the first body and the second body, a support surface with an extension in parallel with the rotation plane of the first body and of the second body, which protrudes beyond at least one workpiece contact surface and is placeable on a workpiece surface.

In this manner, stable support on the workpiece surface can be achieved, which goes beyond the support surface of the second body and also the work component, which can be coupled, and in particular is also spaced apart therefrom in the plane of the workpiece surface. This spaced disposition increases the support stability. In particular in the case of long first bodies, the first body and thus the angle stop can therefore be prevented, by virtue of gravity, from hanging freely in the air on the side spaced apart from the support surface of the second body and the work component and the angle stop can be prevented from twisting. The support surface of the first body can also assume the task of the support surface for supporting on the workpiece surface on the subsequently described extension, which can be coupled, and vice-versa.

According to one embodiment, the first body has a clamp surface arrangement, in particular for each workpiece contact surface, which protrudes beyond the corresponding workpiece contact surface, wherein the clamp surface arrangement has a support surface with an extension in parallel with the rotation plane x-y of the first body and the second body, which protrudes beyond at least one workpiece contact surface and is placeable on a workpiece surface, and a clamp contact surface opposite the support surface for accommodating a clamp.

In this manner, a surface and a contact surface can be provided, upon/to which a clamp acts and can be fixed and by means of which the angle stop can be fixed to the workpiece.

According to one embodiment, at least one contact pin is provided on the first body, which extends in a transverse extension direction z of the workpiece contact surface or in parallel with a transverse extension direction of the workpiece contact surface.

In this manner, the contact region can be widened and even more greatly rounded edges and bevels at the transition between the workpiece surface and workpiece side surface can be bridged in order to achieve precise contact on the workpiece side surface. Furthermore, any protrusions on the workpiece side surface can be avoided, when these do not lie directly in the region of the contact pins.

According to one embodiment, two contact pins are provided on the first body, which extend in a transverse extension direction z of the workpiece contact surface or in parallel with a transverse extension direction of the workpiece contact surface.

In this manner, precise angle orientation is possible because the orientation is fixedly defined when two pins are in contact. Furthermore, any protrusions on the workpiece side surface can also be avoided in this case, when these do not lie directly in the region of the contact pins.

According to one embodiment, the two contact pins are positioned on the first body spaced apart from each other, corresponding to a grid dimension of 96 mm or a multiple thereof

In this manner, the two contact pins are engageable into a work plate which has recesses in a grid of 96 mm. The angle stop together with the workpiece and the work component thus is fixable on a work plate with such grid recesses. “Grid dimension” is understood to mean the dimension derived from the centre of one pin to the centre of the other pin, similar to that derived from the centre of a cut-out to the centre of an adjacent cut-out in the grid.

According to one embodiment, the at least one contact pin is releasable fixable to the first body.

In this manner, the pin(s) can be removed as required when it/they is/are no longer needed or would be for instance in the way, e.g. when the angle stop with the work component fixed thereon is to lie flat on a planar surface.

According to one embodiment, the at least one contact pin is displaceable in the longitudinal extension direction of the workpiece contact surface.

In this manner, the contact pin can be displaced in the longitudinal extension direction in order to either correspond with another grid dimension of a work plate with recesses in the grid or to avoid any protrusions or recesses in the workpiece side surface and achieve suitable contact on the workpiece side surface.

According to one embodiment, the angle stop has a storage receptacle for at least one contact pin.

In this manner, the contact pin can always be stored on the angle stop in a loss-proof manner when not in use. Storage can be effected in a cut-out or trough in which the contact pin can be fixed by means of a clip and clamp mechanism, in particular such that it can be removed using one hand. According to one embodiment, two such storage receptacles for contact pins can be provided, or one storage receptacle can be provided which is suitable for receiving two contact pins.

According to one embodiment, the storage receptacle for the at least one contact pin is provided on the second body.

In this manner, the contact pin in the storage receptacle is always within reach.

According to one embodiment, the at least one contact pin has a substantially cylindrical longitudinal extension.

In this manner, the contact pin can engage into a recess of a work plate in a defined manner, irrespective of the depth to which it engages in the recess. Furthermore, the contact plane on which the contact pin contacts the workpiece is always the same owing to the cylindrical shape of the contact pin, irrespective of the distance of the contact point from a workpiece edge.

According to one embodiment, the at least one contact pin has a cross-section transverse to the longitudinal extension which has a substantially circular intrinsic curve, wherein the intrinsic curve has in particular a diameter of 20 mm.

In this manner, the contact pin always has the same contact plane to the workpiece side surface, irrespective of its rotation orientation. A diameter of substantially 20 mm allows accurately-fitting insertion into a corresponding work plate with recesses having a diameter of 20 mm or square recesses with an edge length of 20 mm.

According to one embodiment, the at least one contact pin is produced from a polymer.

In this manner, the contact pin has a small coefficient of friction compared with the most used materials of a workpiece and also of work plates with grid recesses.

According to one embodiment, the connector arrangement is designed to exert a clamping force on a structure of a work component to be fixed, in a perpendicular direction on the work component contact surface, in order to fix the work component to be fixed, in relation to the second body.

In this manner, a clamping force can be generated in a direction different from the direction of the support on a workpiece surface. This permits secure fixing of the work component to the angle stop, in particular to the second body of the angle stop.

According to one embodiment, the second body has a receiving structure being designed to pre-position a corresponding structure of the work component to be fixed, prior to clamping.

In this manner, simple orientation can be effected, before the work component is fixed to the second body. For this purpose, the second body can comprise a further guide protrusion having a contact surface which engages over a web or profile of the work component. This permits the angle-precise orientation of the work component in relation to the second body, and so the angle to be fixed, can be fixed precisely.

According to one embodiment, the clamping force has a force component in parallel with the rotation plane x-y of the first body and of the second body.

In this manner, the fixing force can be applied in parallel with the support surface of the work component on the workpiece surface, which increases the stability of the angle stop with respect to the work component to be fixed.

According to one embodiment, the connector arrangement has a clamp lever pivotably fixed on the second body and a clamp element pivotably fixed on the clamp lever, wherein the clamp element and the clamp lever cooperate such that pivoting of the clamp lever by the user results in pivoting of the clamp element such that the clamp element exerts a clamping force on said structure of the work component to be fixed, in the direction of the work component contact surface.

In this manner, simple and rapid fixing of the work component to the second body of the angle stop can be achieved. Furthermore, a lever force of the clamp lever can be used in order to simply and rapidly generate a high clamping force without the use of tools.

According to one embodiment, the clamp lever is designed to lie substantially in parallel with a rotation plane of the first body and the second body in a fixing state.

In this manner, the angle stop can be designed with a flat structure and the clamp lever closely contacts the angle stop in the fixing state and thus does not obstruct the user during machining of the workpiece.

According to one embodiment, the clamp element has a hook at one end exerting the clamping force, said hook being designed to engage behind an undercut in said structure of the work component to be fixed.

In this manner, the clamp element can be prevented from slipping off the work component. The clamp lever and the clamp element can furthermore be designed to be fixed in a movable manner with a four-bar articulation on the angle stop such that when the clamp lever is released the clamp element is automatically raised to a side facing away from the angle stop. In this manner, hooking of the clamp hook on the work component can be avoided and constraint-free work when fixing and disconnecting the work component on the angle stop can be made possible.

According to one embodiment, a guide rail having a stabilising body arranged in a displaceable manner therein is arranged in the first body, wherein the stabilising body is designed to engage into a corresponding recess in a work component to be fixed, wherein the stabilising body is displaceable along the guide rail in dependence upon an angle-defined orientation of the first body and the second body with respect to each other.

In this manner, more stable guidance of the work component in relation to the angle stop can be achieved. Since the required distance between the stabilising body along the guide rail and the second body changes depending upon the angle orientation of the first and second body, the stabilising body can be changed in terms of the distance in this manner. The stabilising body can have a T-shaped cross-section in the longitudinal extension direction of the contact surface for the work component, and so this can engage into a corresponding guide groove with a lateral overhang of the work component, without slipping out of the guide groove at the top or bottom.

According to one embodiment, the guide rail has a straight trajectory.

In this manner, uncomplicated displacement and positioning of the stabilising body in relation to the guide rail can be achieved.

According to one embodiment, the trajectory has an orientation in parallel with the longitudinal extension direction of the workpiece contact surface.

In this manner, a minimal length of the guide rail can be achieved with maximum angle deflection on both sides.

According to one embodiment, the first body has a fixing arrangement or fixing component or means which is designed for fixing the stabilising body with respect to the guide rail.

In this manner, additional stabilisation with respect to the clamp fixing by the quick connection element between the work component and the angle stop can be achieved.

According to one embodiment, the second body is orientable in a rotation plane x-y with respect to the first body such that the longitudinal extension direction of the work component contact surface is orientable with respect to a perpendicular to the longitudinal extension direction of the workpiece contact surface by at least +/−60 degrees.

In this manner, a wide angle range can be covered in both deflection directions with respect to the right-angled orientation of the first body and second body, which angle range corresponds on the whole to a third of a complete circle. This allows a wide working area and, in relation to the workpiece side surface, flat angle cuts using, for instance, a saw guided by the work component.

According to one embodiment, one of the first body and the second body has an angle scale and the other one of the first body and the second body has an angle pointer.

In this manner, the set angle can be easily read by the user and can be rendered transparently visible.

According to one embodiment, the scale is arranged along a circular arc about the axis of rotation between the first and second bodies.

In this manner, a large reading area can be provided on the angle scale and an immediate visual reference to the angular rotation during angle orientation can be achieved by the correspondence between the axis of rotation of the first and second bodies and the centre point of the circular arc-shaped scale.

According to one embodiment, one of the first body and the second body has a cylinder jacket section-shaped detent surface with at least one detent geometry and the other one of the first body and the second body has at least one counter-detent geometry, wherein the detent geometry and the counter-detent geometry are designed for latching the first body and the second body in at least one predetermined angle position.

In this manner, latching or pre-latching in predetermined angle positions can be achieved which allows precise setting of the predetermined angle(s). Latching prevents unintended adjustment of the angle when fixing the angle position.

According to one embodiment, a number of detent geometries and a number of counter-detent geometries are provided on the cylinder jacket section-shaped detent surface such that the first body and the second body are latchable at a plurality of predetermined angle positions.

In this manner, several predetermined angles can be fixed, in which pre-latching can occur in order to avoid unintended adjustment of the angle during fixing.

According to one embodiment, the plurality of predetermined angle positions has at least two of the following angles: 0 degrees, +/−15 degrees, +/−22.5 degrees, +/−30 degrees, +/−45 degrees, +/−60 degrees.

In this manner, frequently used angle positions can be predefined. In particular, in addition to the 0 degree position, on each side two predetermined angle positions can be provided, in particular +/−30 degrees and +/−45 degrees. All of the above-mentioned predetermined angle positions can also be provided, allocated with latching positions.

According to one embodiment, depressions are provided on the circular arc-shaped detent surface as detent geometries and a resiliently mounted element being latchable into the depressions in a spring-biased manner are provided as a counter-detent geometry.

In this manner, resilient latching and also unlatching can be achieved which permits secure fixing of the angle in a haptic manner, whilst also allowing simple vacating of the latching position.

According to one embodiment, the resiliently mounted element is a spring-loaded ball.

In this manner, simple, easy and low-wear latching and unlatching is permitted.

According to one embodiment, a lock is provided on the counter-detent geometry which is movable alternately between a state allowing movement of the resiliently mounted element and a state blocking movement of the resiliently mounted element.

In this manner, unintended adjustment of a set angle can be avoided. In particular, a pre-set latching angle can be blocked and thus fixedly set or can also be released. The lock can also be designed such that it can also fix angles outside of the detent positions by, for instance, applying a high frictional force. The lock can be produced for example by a slide e.g. in the proximity of an angle indicator. The blocking position and the releasing position can be marked for example by the words “ON” and “OFF” or even by corresponding coloured marking e.g. red for blocked and green for released.

According to one embodiment, the resiliently mounted element is provided on the first body and the cylinder jacket section-shaped detent surface with the depressions is provided on the second body.

In this manner, in particular a resilient detent element can be arranged e.g. once centrally and the depressions, which are easier to produce from a technical point of view, can be provided multiple times on or at the angle scale.

According to one embodiment, the cylinder jacket section-shaped detent surface is oriented perpendicularly to the rotation plane x-y of the first body and of the second body.

In this manner, a flat structure for the angle stop can be achieved when the detent geometry acts radially to the axis of rotation of the first and second bodies.

It will be understood that the above-described embodiments can also be combined together and synergistic interactions can be produced which go beyond the sum of the individual effects and thus substantiate an inventive step.

The embodiments are explained hereinafter with the aid of the figures listed and the mode of operation thereof is illustrated with the aid of the exemplified embodiments shown.

### BRIEF DESCRIPTION OF THE FIGURES

The invention is described with the aid of the following figures, in which:

FIG. 1 shows a perspective overall view of the angle stop in accordance with the invention in the non-mounted state,

FIG. 2 shows a perspective bottom view of the angle stop in accordance with the invention with stop pins on a workpiece, which does not have sharp edges, in the mounted state,

FIG. 3 shows a perspective bottom view of the angle stop in accordance with the invention on a workpiece, which has sharp edges, in the mounted state,

FIG. 4 shows a perspective top view of the angle stop in accordance with the invention with a work component oriented with respect to a workpiece at a non-right angle, and

FIG. 5 shows a perspective top view of the angle stop in accordance with the invention with an extension, which can be—and is—coupled, contacting a workpiece with a work component oriented at a right angle.

It will be understood that the same reference signs designate the same or similar components, and similar reference signs with analogous sign conformity designate analogous or corresponding components.

### DETAILED DESCRIPTION

Embodiments of the invention will be described hereinafter with the aid of the figures. It will be understood that the aspects and elements described with respect to some figures also apply analogously to other figures, for which these aspects and elements will not be described again.

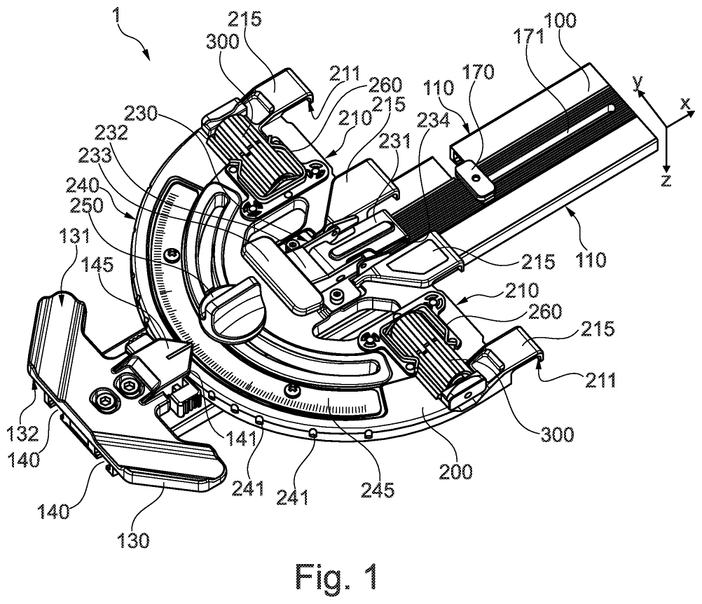

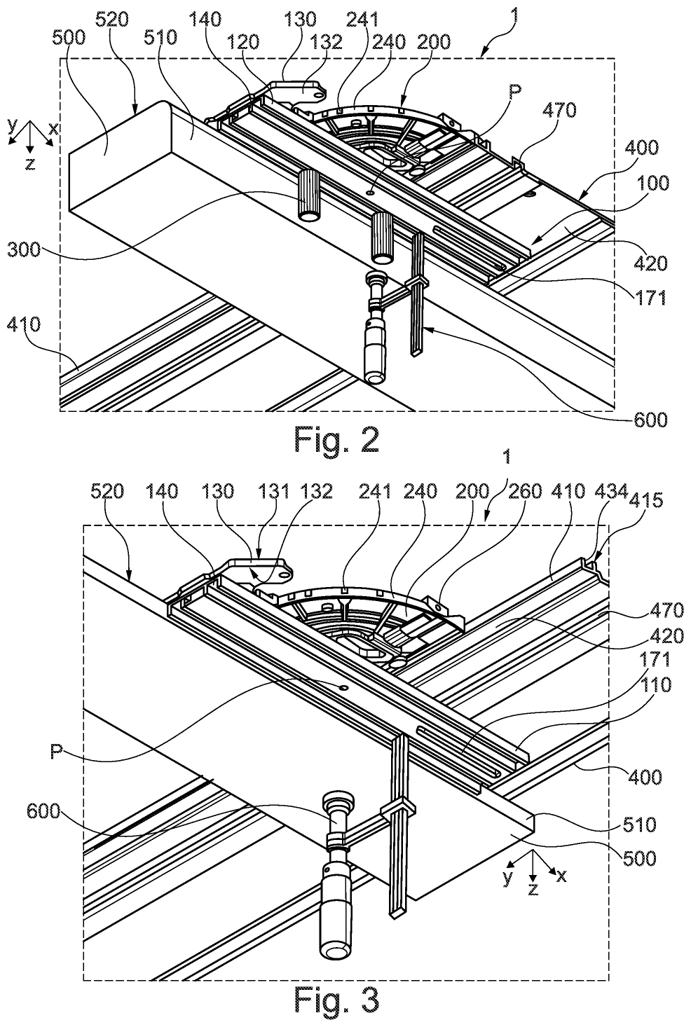

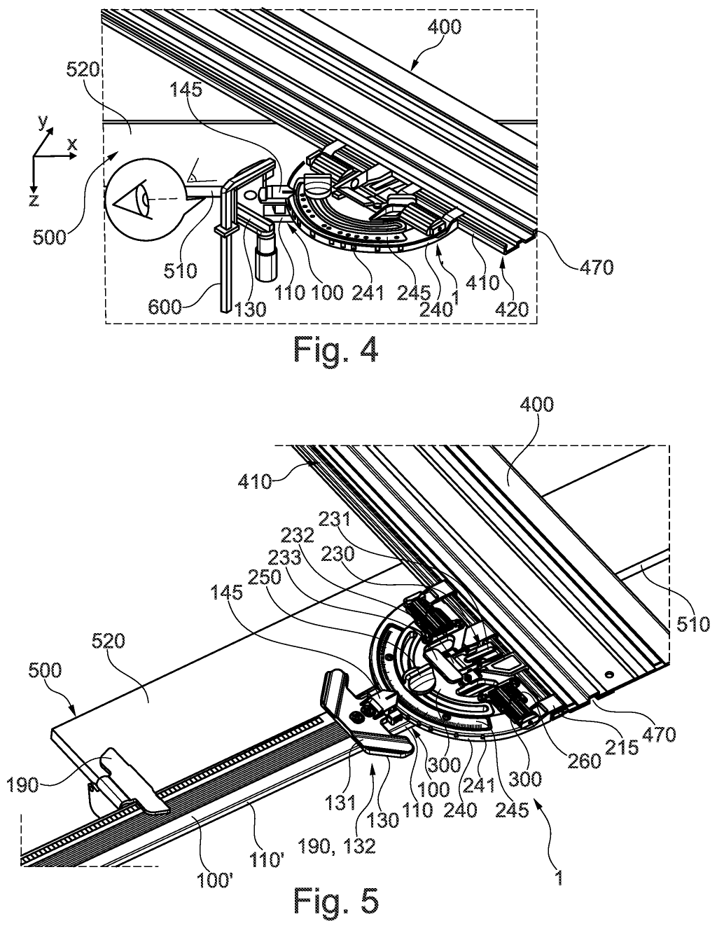

FIG. 1 shows a perspective overall view of the angle stop 1 in accordance with the invention in the non-mounted state and without any fixed work component or guide rail 400. The angle stop 1 illustrated in FIG. 1 has a first body 100 and a second body 200. The first body is used to contact a workpiece 500 (not shown here) and has a workpiece contact surface 110 for contacting the workpiece. This contact surface 110 can be provided on both sides of the longitudinal extension direction x. The surface thereof extends in the x-z plane for contacting a workpiece side surface 510 of a workpiece 500, not shown here. The angle stop 1 with a work component 400 fixed thereto is shown in FIG. 5 in which the angle stop 1 is shown placed against a workpiece 500, wherein a contact surface 110 in FIG. 5 contacts the workpiece side surface 510. The second body 200 is connected to the first body at a centre of rotation P so as to be rotatable about an axis of rotation. The centre of rotation P is concealed by a lever mechanism 230, 231, 233 in FIG. 1. However, the position of the centre of rotation P can be seen in FIG. 2. The second body 200 has a work component contact surface 210, against which a work component or guide rail 400 having a corresponding counter-contact surface 410 can be placed and can be fixed in relation to the second body 200. As can be seen in FIG. 5, the work component 400 in the fixed state is supported on a workpiece surface 520 of the workpiece 500. In this manner, the first body 100 and the second body 200 are connected together and can be oriented with respect to each other in an angle-defined manner in a rotation plane x-y. For instance, the work component contact surface 210 can be oriented in an angle-specific manner in relation to the workpiece contact surface 110 in order to orient said work component 400, to be fixed and can be placed on the workpiece surface 520, in an angle-defined manner in relation to said workpiece side surface 510. The embodiment shown in FIG. 1 permits angle setting proceeding from the perpendicular orientation, as shown in FIG. 1, of the second body 200 with respect to the first body by +/−60 degrees. The principle of angle orientation can be seen in FIG. 4.

The workpiece contact surface 110 of the first body has a longitudinal extension direction x in a rotation plane x-y of the first body 100 and of the second body 200, and a transverse extension direction z with an inclination with respect to the rotation plane x-y of the first body 100 and of the second body 200. The inclination is orthogonal in FIG. 1, the transverse direction of the contact surface 110 of the first body thus extends perpendicularly in the z direction with respect to the rotation plane x-y between the first and second bodies 100, 200. The work component contact surface 210 has a longitudinal extension direction y in a rotation plane x-y of the first body 100 and of the second body 200 oriented at a right angle as shown in FIG. 1. The work component contact surface 210 further has a transverse extension direction z with an inclination with respect to the rotation plane x-y of the first body 100 and of the second body 200. The inclination is orthogonal in FIG. 1, i.e. the transverse direction of the work component contact surface 210 of the second body 200 extends perpendicularly with respect to the rotation plane x-y between the first and second bodies 100, 200 in the z direction.

Coupling of the work component or guide rail 400 to the second body 200 is effected via a connector arrangement 230 or quick connector system. The connector arrangement 230 is designed to fix the work component 400, to be fixed, to the work component contact surface 210 by means of a quick closure clamping process. The connector arrangement 230 can exert a clamping force on a structure 415, shown in FIG. 3, of the work component 400, to be fixed, and acting upon this structure 415 can press a contact surface 410 of the work component against the contact surface 210 of the second body. The structure 415 can be a U-profile provided on the work component 400 and extending in the longitudinal extension direction y of the work component 400 in FIG. 3. The U-profile 415 can be provided with an overhang 434 which allows rearward engagement of a hook 234, which will be described hereinafter, on the connector arrangement 230 in order to avoid slippage. In this manner, a clamping force can be exerted in the x direction shown in FIGS. 1 and 3 and is exerted in the perpendicular direction on the work component contact surface 210 in order to fix the work component 400, to be fixed, with respect to the second body 200. The clamping force has a force component in parallel with the rotation plane x-y of the first body 100 and of the second body 200. For improved guidance and pre-positioning of the work component 400, in particular the structure or U-profile 415 thereof, a receiving structure 215 can be provided on the second body 200 in order to pre-position a corresponding structure 415 of the work component 400, to be fixed, prior to clamping. This receiving structure 215 can be an overarching arm which has, opposite the contact surface 210, a guide surface 211 for the work component 400, in particular the structure or U-profile 415 of the work component. In the embodiment shown in FIG. 1, this receiving structure 215 and the guide surface 211 are provided multiple times and so conformal positioning of the work component 400 in contact with the second body 200 can be performed, before fixing by the connector arrangement 230 is performed.

The connector arrangement 230 comprises a clamp lever 232 pivotably fixed to the second body 200 and a clamp element 231 pivotably fixed to the clamp lever 232. The clamp element 231 and the clamp lever 232 cooperate such that pivoting of the clamp lever 232 by the user results in pivoting or displacement of the clamp element 231 such that the clamp element 231 exerts a clamping force on said structure 415 of the work component 400, to be fixed, in the direction of the work component contact surface 210. The clamp lever 232 is in this case rotatably fixed to the second body and the clamp element 231 is rotatably fixed to the clamp lever 232. An articulation arm, not shown here, can also be provided being on the one hand fixed to the clamp element 231 in an articulated manner and is also fixed to the second body 200 in an articulated manner in order to form, together with the clamp lever 232, the clamp element 231 and the second body 200, an articulation quadrilateral. This can be sized such that the clamp element 231 is automatically lifted when the clamp lever 232 is pivoted into a position disconnecting the connection, in order to lift the clamp element 231 from the U-profile 415 shown in FIG. 3, in particular away from the overhang 434, and so the work component 400 is released. In a similar manner, the clamp element 231 can be automatically lowered, when the clamp lever 232 is pivoted, into the fixing position and any hook 234 provided on the end thereof can be lowered into the U-profile 415 behind the overhang 434 without the user again having to ensure that the clamp element 231 actually acts upon the structure 415 and does not slide beyond it. In the fixed state, the clamp lever 232 lies substantially in parallel with the rotation plane x-y of the first body 100 and of the second body 200 and thus substantially flat on the surface of the angle stop 1. As a result, the lever is prevented from obstructing the user whilst he is working or items of clothing are prevented from hooking thereon.

The angle stop 1 further has an angle fixing device 250, by means of which an angle selected and set by the user between the first body 100 and the second body 200 can be fixed and also then released. This angle fixing device 250 can be a clamping screw, by means of which the second body 200 is pressed onto the first body 100 in order to prevent angle adjustment by way of frictional engagement. The clamping screw can have a handle which allows the screw to be tightened and loosened by hand. The handle can be designed and positioned in proximity to the clamp lever 232 such that it virtually shields the clamp lever in respect of items of clothing and thus contributes to the fact that any items of clothing from the user sliding over the angle stop are guided by the handle over the clamp lever without hooking therein.

In the angle stop shown in FIG. 1, the second body 200 is oriented, with respect to the extension direction of the work component or guide rail 400, to be fixed, orthogonally to the extension direction of the workpiece contact surface 110 of the first body 100. An orientation different from the orthogonal orientation is shown in FIG. 4.

As can be seen in FIG. 1, the angle stop has, in the first body 100, a guide rail 171 having a stabilising body 170 arranged to be displaceable therein. The stabilising body or even sliding block 170 engages into a corresponding recess 470, shown in FIG. 2, of a work component 400 to be fixed. Since the recess or U-profile 470 of the work component 400, to be fixed, does not extend through the centre of rotation P, the distance between the recess 470 and the stabilising body 170 and the guide rail 171 changes. Allowance is made for this in that the stabilising body 170 which can be displaced in the guide rail 171 can change the distance and can engage into the recess 470 in a stabilising manner at different angle positions. In the embodiment shown in FIG. 1, the trajectory of the guide rail 171 is oriented straight or linear and in parallel with the longitudinal extension direction x of the workpiece contact surface 110. However, the trajectory can also be curved, which facilitates displacement of the stabilising body 170 upon angular rotation in the bending direction in the recess 470, since the transverse forces are reduced. The recess 470 can be designed to be groove-shaped and so the stabilising body 170 can slide along therein. The recess 470 can be provided in the form of a U-profile formed on the work component 400 and can likewise comprise an overhang which prevents the stabilising body from slipping out of the groove 470, in particular when the stabilising body 170 is designed with a T-shaped head. In that case, the stabilising body 170 can only be unthreaded and threaded at corresponding cut-outs of the overhang or at the ends of the U-profile 470. It will be understood that the recess or groove 470 in the exemplified embodiment shown here is open towards the workpiece surface at the bottom, whilst the structure or groove 415 is open at the top. The stabilising body 170 can comprise fixing component, system, or means, not visible here, by means of which the stabilising body 170 can be fixed with respect to the guide rail 171. Furthermore, the stabilising body 170 can comprise fixing coponent, not visible here, by means of which the stabilising body 170 can be fixed to the work component 400 with respect to the recess 470.

In the embodiment shown in FIG. 1, the angle stop has, on the first body spaced apart from a centre of rotation or coupling region P of the first body 100 and of the second body 200, a clamp surface arrangement 130 having a support surface 132 with an extension in parallel with the rotation plane x-y of the first body 100 and of the second body 200. The support surface 130 protrudes beyond the workpiece contact surface 110 and is supported on a workpiece surface 520, as can be seen in FIG. 4 and FIG. 5. This support surface is used to achieve stable support on the workpiece surface and to prevent tipping of the angle stop. In a similar manner to a second opposite workpiece contact surface 110, 120, this support surface can also be provided on the opposite side. This contact surface can also be used to receive a clamp 600, by means of which the angle stop can be fixed to the workpiece 500, as shown in FIG. 4. For this purpose, a clamp receptacle 131 can be provided which is designed such that a clamp 600 cannot slip off to the side, for instance by reason of lateral walls or beads. This can be provided on both sides, as shown in FIG. 1.

In the embodiment shown in FIG. 1, the angle stop has, on the second body 200, an angle scale 245 and, on the first body 100, an angle pointer 145. The allocation of angle scale 245 and angle indicator 145 can also occur the other way round with a scale 245 on the first body 100 and an indicator 145 on the second body 200. However, in the exemplified embodiment shown in FIG. 1, the orientation of the work component 400, to be fixed, can be immediately read. In this case, the scale 245 is arranged along a circular arc about the centre of rotation P as the centre point. In this manner, the angle scale is not distorted as would be the case e.g. for a projection on a straight line. In the exemplified embodiment shown in FIG. 1, the second body 200 has a cylinder jacket section-shaped detent surface 240, in this case substantially following the scale 245 and in this case having a multiplicity of detent geometries 241. Provided on the first body is a counter-detent geometry 141 which can engage into one of the plurality of detent geometries 241 in order to latch the first body 100 and the second body 200 in a plurality of predetermined angle positions. The detent geometries 241 can be formed by recesses, depressions, notches or the like whilst the counter-detent geometry 141 can be formed by e.g. a spring-loaded protrusion, for instance a spring-loaded ball. As shown in FIG. 1, the detent direction can be perpendicular to an axis of rotation between the first body 100 and the second body 200 which renders the latching mechanism very flat and does not present an obstacle when working with the angle stop. In the embodiment shown in FIG. 1, detent geometries 241 and counter-detent geometry/geometries 141 are provided so that the predetermined angle positions have the following angles: 0 degrees, +/−15 degrees, +/−22.5 degrees, +/−30 degrees, +/−45 degrees, +/−60 degrees. If the counter-detent geometry 141 is provided at the level of the angle pointer, the corresponding detent geometries 241 are then located at the stated angle positions. A plurality of counter-detent geometries 141 can also be provided which facilitate latching even at angles located closely to each other if depressions 241 cannot be arranged immediately next to each other, but this is not shown in FIG. 1. The spring-loaded counter-detent geometry 141 can be prevented from deflecting out of the detent position by means of a lock in order to prevent unintended vacating of the set angle position. The lock can be provided directly on the angle indicator 145 and produced by means of a slide which can be provided with markings which indicate its position: latched/unlatched.

FIG. 2 shows a perspective bottom view of the angle stop in accordance with the invention with stop pins on a workpiece, which does not have angled edges, in the mounted state. Instead of a flat and planar workpiece contact surface 110 on the first body 100, contact pins fixed to the first body 100 can also assume the task of the workpiece contact surface 110. This is particularly important when the transverse direction in the z direction of the workpiece contact surface 100 of the first body is not sufficient to reliably reach over a curved, broken or bevelled edge. In particular when the transverse extension length in the z direction of the contact surface 110 is smaller than a curved transition between the workpiece surface 520 and workpiece side surface 510, an extension of workpiece contact surface 100 by contact pins 300 may help achieve secure contacting of the angle stop 1 on the workpiece side surface 510. The contact plane may be the same as that of the planar contact surface 110. FIG. 2 shows two contact pins 300 which are fixed at the bottom to the first body. It is also possible for more than two contact pins 300 to be provided. The contact pins can be spaced apart from each other in a grid dimension of a work plate so that the contact pins 300 can engage into depressions of a work plate, not shown here, at any detent position and the angle stop with the work component 400 fixed thereto and the fixedly clamped workpiece 500 can be fixed to a work plate, not shown here. In this case, the distance between the contact pins from pin centre to pin centre can be 96 mm or a multiple thereof in order to be able to engage into a corresponding multifunctional work plate with a grid dimension of 96 mm for depressions or recesses. The pins can also be arranged in a displaceable manner in order to be able to be set to other grid dimensions. The pins can have a diameter of 20 mm or, if they are provided with longitudinal channels or longitudinal recesses, a circular cross-sectional intrinsic curve having a diameter of 20 mm in order to be able to engage into corresponding depressions with an inner dimension of 20 mm. The pins can be produced from a polymer which has a small coefficient of friction compared with a receptacle in a work plate. The contact pins can also have a surface with increased adhesion which prevents slippage from the workpiece side surface 510. Different contact pins can be provided which the user can replace as required.

The contact pins can be provided in a releasable manner on the first body 100 and can be coupled and uncoupled, in particular screwed and unscrewed, as required. If the contact pins are not required, then these can be unscrewed and placed in storage receptacles 260 on the angle stop, as shown in FIG. 1. The storage receptacle 260 can have a depression or trough for receiving one or more contact pins and a clip, clamp or detent arrangement by means of which the contact pin 300 is held in the storage receptacle 260. The storage receptacle 260 having the arrangement locking the contact pin(s) 300 is for example configured such that the contact pin(s) 300 can also be removed and placed back using one hand whilst the user is wearing work gloves. It is also possible for a plurality of storage receptacles 260 to be provided, as shown in FIG. 1 and FIG. 5.

FIG. 3 shows a perspective bottom view of the angle stop in accordance with the invention on a workpiece, which has edges, in the mounted state. In contrast to the case shown in FIG. 2, in FIG. 3 the transition between the workpiece surface 520 and workpiece side surface 510 is somewhat sharp-edged. Therefore, the application shown in FIG. 3 does not require any contact pins 300. As can be seen in FIG. 1, FIG. 2 and FIG. 3, the first body 100 can have, in the workpiece contact surface 110, a bulge, by means of which a clamp 600 can engage past the workpiece as far as onto the workpiece top side in order to be able to engage e.g. into the recess 470. In this manner, the angle stop 1 can be fixedly clamped instead of via the clamp surface 132 or additionally via the coupled work component 400 to the workpiece surface 520 via a corresponding contact surface 420 of the work component 400 to the workpiece surface 520. Although not shown here, the bulge can also be provided on the workpiece contact surface 120 which lies opposite the workpiece contact surface 110 contacting the workpiece shown in FIG. 2.

FIG. 4 shows a perspective top view of the angle stop in accordance with the invention with a work component oriented with respect to a workpiece at a non-right angle. In this figure, the longitudinal extension direction of the work component does not correspond to the indicated direction but is rotated with respect thereto in the x-y plane. As can be seen in FIG. 4, the first body 100 and the work component 400 fixed to the second body 200 are oriented in an angle-defined manner with respect to each other in a rotation plane x-y about an axis of rotation in the z direction. The angle stop 1 is fixedly clamped by means of a clamp 600 via the clamp surface arrangement 130 to the workpiece 500 on the workpiece surface 520. The set angle position can be read on the angle scale 245 on the second body 200 via the angle pointer 145 on the first body 100, the angle position indicating the orientation of the work component 400 with respect to the workpiece side surface 510. The clamp surface arrangement 130 can be provided for each of the two opposite workpiece contact surfaces 110, wherein the clamp surface arrangement 130 allocated to the contacting workpiece contact surface 110 protrudes beyond the workpiece edge and is supported with the support surface 132 on the workpiece surface 520. The clamp contact surface 131 opposite the support surface 132 is then used for receiving a clamp 600, as shown in FIG. 4.

FIG. 5 shows a perspective top view of the angle stop in accordance with the invention with an extension 100′, which can be coupled, contacting a workpiece 500 with a work component 400 oriented at a right angle. The angle stop 1 has, with respect to the first body 100, an extension 100′, which can be coupled, in the longitudinal extension direction x of the first workpiece contact surface 110. The extension 100′, which can be coupled, likewise has a workpiece contact surface 110′ which continues in the plane of the workpiece contact surface 110 of the first body 100 and enlarges the entire workpiece contact surface of the angle stop 1. Coupling of the extension 100′, which can be coupled, can be effected via a receptacle 140 for coupling the extension 100′, which can coupled, to the first body, as shown in FIG. 1. The connection can be achieved via coupling pieces and via a screw connection.

Just like the first body 100 comprises the support surface 132, the extension 100′, which can be coupled, can also have a support surface 190 for supporting on the workpiece surface 520. This has a similar function to the support surface 132 of the first body 100 and not only assists with achieving contact on the workpiece side surface 510 but also with providing support points over a wide area for supporting on the workpiece surface 520, even in the case of relatively long workpiece contact surfaces on the first body 100.

### LIST OF REFERENCE SIGNS

1 angle stop
100 first body of the angle stop
100′ extension, which is coupleable, on the first body
110 workpiece contact surface/first workpiece contact surface of the first body
120 second workpiece contact surface of the first body
110′ extended workpiece contact surface, workpiece contact surface of the extension, which is coupleable
130 clamp surface arrangement on the first body
131 clamp contact surface as a contact surface for clamp
132 support surface on the first body for supporting on the workpiece surface
140 receptacle for coupling the extension which is coupleable
141 counter-detent geometry, counter-detent geometry on the first body
145 angle indicator, angle indicator on the first body
170 stabilising body, sliding block
171 guide rail for stabilising body, sliding block
190 support surface on the extension, which is coupleable, for supporting on the workpiece surface
200 second body of the angle stop
210 work component contact surface of the second body
211 guide surface for the work component, structure of the work component
215 receiving structure for (pre-)positioning the structure of the work component
230 connector arrangement, quick connection system, component, or means, clamp lever connection system, component, or means
231 clamp element, pivotable clamp element, clamp engagement element
232 clamp lever, pivotably fixed clamp lever
233 handle, pressure surface, engagement element of the clamp lever
234 hook on clamp element 231, hook for engaging an undercut on the work component
240 detent surface, cylinder jacket section-shaped detent surface on the second body
241 detent geometry on the detent surface
245 angle scale, angle scale on the second body
250 angle fixing device between the first and second bodies
260 storage receptacle for contact pin
300 contact pin for contacting the workpiece side surface
400 work component, ruler, tool guide rail
410 contact surface of the work component, of the structure on the work component contact surface of the second body
415 clamp structure, clamp engagement surface on the work component to be fixed, groove
420 support surface of the work component on the workpiece surface
434 undercut on the work component, undercut on the structure of the work component to be fixed
470 recess, receiving rail, receiving groove on the work component to be fixed, for receiving the stabilising body, sliding block
500 workpiece
510 workpiece side surface, workpiece edge
520 workpiece surface, workpiece machining surface
600 clamp for fixing the angle stop to the workpiece
x longitudinal extension direction of the first body, longitudinal extension direction of the workpiece side surface / workpiece edge
y longitudinal extension direction of the second body at an orthogonal orientation with respect to the first body
z transverse extension direction, direction of the axis of rotation between the first and second bodies, perpendicular to the workpiece surface
x-y rotation plane of the first and second bodies, plane of the workpiece surface
x-z plane of the workpiece side surface / contact surface of the first body
y-z plane of the work component contact surface of the second body at an orthogonal orientation with respect to the first body
P centre of rotation on the axis of rotation between the first and second bodies

1. An angle stop resiliently comprising:
a first body having a first workpiece contact surface for contacting a workpiece side surface of a workpiece;
a second body having a work component contact surface for contacting a work component to be fixed to the second body, wherein the work component in a fixed state is placeable on a workpiece surface of said workpiece;
a connector for fixing the work component to the second body, wherein the connector is designed for fixing said work component to be fixed, to the work component contact surface by a quick closure clamping process;
an angle fixing device;
wherein the workpiece contact surface has a longitudinal extension direction in a rotation plane of the first body and the second body, and a transverse extension direction with an inclination with respect to the rotation plane of the first body and the second body;
wherein the work component contact surface has a longitudinal extension direction in the rotation plane of the first body and the second body, and a transverse extension direction with an inclination with respect to the rotation plane of the first body and the second body;
wherein the first body and the second body are connected together and are orientable with respect to each other in an angle-defined manner in the rotation plane for orienting the work component contact surface in relation to the workpiece contact surface for orienting said work component to be fixed and being placeable on the workpiece surface, in relation to said workpiece side surface with respect to each other in an angle-defined manner;
wherein the angle fixing device is designed to fix the first body and the second body with respect to each other in an angle-stable manner.

2. The angle stop of claim 1, wherein the first body and the second body are orientable with respect to each other in an angle-defined manner in the rotation plane about a centre of rotation, and wherein the angle fixing device is switchable between a first state for enabling a rotation between the first body and the second body, and a second state for blocking a rotation between the first body and the second body.

3. The angle stop of claim 1, wherein the inclination of at least one of the workpiece contact surface and the work component contact surface is orthogonal to the rotation plane of the first body and the second body.

4. The angle stop of claim 1, wherein the first body has a second workpiece contact surface for contacting a workpiece side surface, the surface normal direction of the second workpiece contact surface being opposite to the surface normal direction of the first workpiece contact surface.

5. The angle stop of claim 1, wherein the first body has an extension, which is coupleable, in the longitudinal extension direction of the first workpiece contact surface, wherein the extension being coupleable, has a workpiece contact surface in a planar continuation of at least one of the workpiece contact surfaces of the first body.

6. The angle stop of claim 1, wherein the first body has, spaced apart from a coupling region of the first body and the second body, a support surface with an extension in parallel with the rotation plane of the first body and the second body, which protrudes beyond at least one workpiece contact surface and is placeable on a workpiece surface.

7. The angle stop of claim 1, wherein the first body has a clamp surface arrangement, for each workpiece contact surface, which protrudes beyond the corresponding workpiece contact surface, wherein the clamp surface arrangement has a support surface with an extension in parallel with the rotation plane of the first body and the second body, which protrudes beyond at least one workpiece contact surface and is configured to be arranged on a workpiece surface, and a clamp contact surface opposite the support surface for accommodating a clamp.

8. The angle stop of claim 1, further comprising at least two contact pins on the first body, which extend in a transverse extension direction of the workpiece contact surface or in parallel with a transverse extension direction of the workpiece contact surface.

9. The angle stop of claim 8, wherein the at least two contact pins are positioned on the first body spaced apart from each other, corresponding to a grid dimension of 96 mm or a multiple thereof.

10. The angle stop of claim 8, wherein at least one of the at least two contact pins is releasable fixable to the first body, and at least one contact pin is displaceable in the longitudinal extension direction of the workpiece contact surface.

11. The angle stop of claim 8, wherein the angle stop has a storage receptacle for at least one contact pin of the at least two contact pins and wherein the storage receptacle for the at least one contact pin is provided on the second body.

12. The angle stop of claim 8, wherein at least one contact pin of the at least two contact pins has a substantially cylindrical longitudinal extension and has a cross-section transverse to the longitudinal extension which has a substantially circular intrinsic curve, in particular a circular intrinsic curve having a diameter of 20 mm, wherein the at least one contact pin in particular is produced from a polymer.

13. The angle stop of claim 1, wherein the connector is designed to exert a clamping force on a structure of a work component to be fixed, in a perpendicular direction on the work component contact surface, to fix the work component to be fixed, in relation to the second body, wherein the clamping force has a force component in parallel with the rotation plane of the first body and the second body, and wherein the second body has a receiving structure designed to pre-position a corresponding structure of the work component, to be fixed, prior to clamping.

14. The angle stop of claim 13, wherein the connector has a clamp lever pivotably fixed on the second body and a clamp element pivotably fixed on the clamp lever, wherein the clamp element and the clamp lever cooperate, whereby pivoting of the clamp lever by the user results in pivoting of the clamp element and wherein the clamp element exerts a clamping force on said structure of the work component to be fixed, in the direction of the work component contact surface, wherein the clamp lever is configured to lie substantially in parallel with the rotation plane of the first body and the second body in a fixed state, and wherein the clamp element has a hook at one end exerting the clamping force, said hook being designed to engage behind an undercut in said structure of the work component to be fixed.

15. The angle stop of claim 1, wherein the first body includes a guide rail having a stabilising body arranged in a displaceable manner therein, wherein the stabilising body is configured to engage a corresponding recess in a work component to be fixed, wherein the stabilising body is displaceable along the guide rail in dependence upon an angle-defined orientation of the first body and the second body with respect to each other, and wherein the guide rail has a straight trajectory, and the trajectory has an orientation in parallel with the longitudinal extension direction of the workpiece contact surface.

16. The angle stop of claim 15, wherein the first body comprises a fixing arrangement configured to fix the stabilising body with respect to the guide rail.

17. The angle stop of claim 1, wherein the second body is orientable in the rotation plane with respect to the first body, whereby the longitudinal extension direction of the work component contact surface is orientable with respect to a position perpendicular to the longitudinal extension direction of the workpiece contact surface by at least +/−60 degrees, and wherein a first of the first body and the second body has an angle scale and a second of the first body and the second body has an angle pointer, wherein the angle scale is arranged along a circular arc about the axis of rotation between the first body and the second body.

18. The angle stop of claim 1, wherein one of the first body and the second body has a cylinder jacket section-shaped detent surface with at least one detent geometry and the other one of the first body and the second body has at least one counter-detent geometry, wherein the detent geometry and the counter-detent geometry are designed to latch the first body and the second body in at least one predetermined angle position, wherein depressions are provided on the circular arc-shaped detent surface as detent geometries and a resiliently mounted element latchable into the depressions in a spring-biased manner is provided as a counter-detent geometry.

19. The angle stop of claim 18, wherein a number of detent geometries and a number of counter-detent geometries are provided on the cylinder jacket section-shaped detent surface to configure the first body and the second body to be latchable at a plurality of predetermined angle positions, wherein the plurality of predetermined angle positions has at least two of the following angles: 0 degrees, +/−15 degrees, +/−22.5 degrees, +/−30 degrees, +/−45 degrees, +/−60 degrees, wherein the resiliently mounted element is a spring-loaded ball.

20. The angle stop of claim 18, further comprising a lock provided on the counter-detent geometry that is movable alternately between a state allowing movement of the resiliently mounted element and a state blocking movement of the resiliently mounted element, wherein the resiliently mounted element is provided on the first body and the cylinder jacket section-shaped detent surface with the depressions is provided on the second body, and wherein the cylinder jacket section-shaped detent surface is oriented perpendicularly to the rotation plane of the first body and of the second body.

21. A method for operating and connecting an angle stop having a first body, a second body and a connector with a work component, the method comprising:
placing the work component on a workpiece surface of a workpiece;
contacting the first body having a first workpiece contact surface with a workpiece side surface of the workpiece;
contacting the second body having a work component contact surface with the work component;
fixing the work component to the second body; and
fixing an angle between the first body and the second body.

22. A set comprising an angle stop and a work component, the set comprising:
a first body having a first workpiece contact surface for contacting a workpiece side surface of a workpiece;
a second body having a work component contact surface for contacting the work component to the second body;
a connector for fixing the work component to the second body, wherein the connector is designed for fixing said work component to the work component contact surface by a quick closure clamping process, wherein the work component in a fixed state is placeable on a workpiece surface of said workpiece;
an angle fixing device;
wherein the workpiece contact surface has a longitudinal extension direction in a rotation plane of the first body and of the second body, and a transverse extension direction with an inclination with respect to the rotation plane of the first body and of the second body;
wherein the work component contact surface has a longitudinal extension direction in the rotation plane of the first body and of the second body, and a transverse extension direction with an inclination with respect to the rotation plane of the first body and of the second body;
wherein the first body and the second body are connected together and are orientable with respect to each other in an angle-defined manner in the rotation plane for orienting the work component in relation to the workpiece contact surface;
wherein the angle fixing device is designed to fix the first body and the second body with respect to each other in an angle-stable manner.
